(19) United States
(12) Patent Application Publication
(10) Pub. No.: US 2018/0080314 A1
(43) Pub. Date: Mar. 22, 2018

(54) METHOD OF ALLOCATING INDIVIDUAL OIL OR WATER PRODUCTION CONTRIBUTIONS FROM MULTIPLE COMBINED SOURCES

(71) Applicant: Spectrum Tracer Services, LLC, Tulsa, OK (US)

(72) Inventors: Jeffrey David Rule, Claremore, OK (US); Steve Allen Faurot, Skiatook, OK (US)

(21) Appl. No.: 15/271,348

(22) Filed: Sep. 21, 2016

(51) Int. Cl. E21B 47/10; E21B 49/08; G01F 1/704

(52) U.S. Cl. CPC E21B 47/1015; G01F 1/704; E21B 49/088

(57) ABSTRACT

A method of production allocation for multiple wells, fields, or other individual production sources which feed a common collection tank or battery. For any or each of the individual production sources, an oil-soluble or water-soluble tracer solution is added to the product stream flowing from the source and one or more downstream samples are then taken prior to the point at which the product stream combines with the product streams from any of the other sources. The individual oil production rate or water production rate of the tested production source is then determined using (i) the concentration of the oil-soluble tracer or water-soluble tracer in the tracer solution, (ii) the rate of addition of the tracer solution to the product stream, and (iii) the downstream concentration of the tracer in the oil phase or the water phase of the product stream.

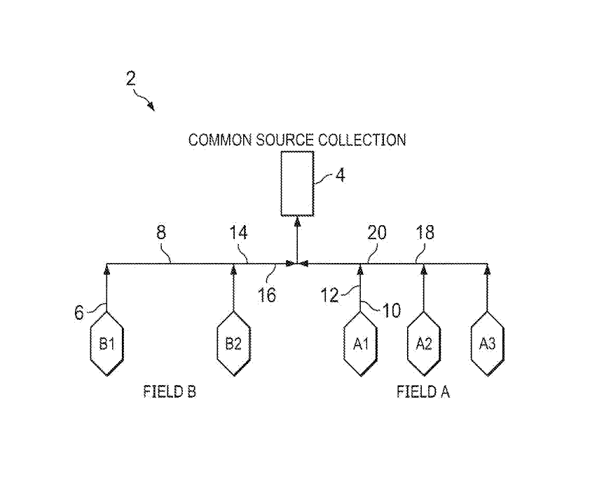

### FIELD OF THE INVENTION

The present invention relates to methods of determining the individual oil or water production contributions of one or more oil wells, one or more groups of oil wells, one or more producing fields, or one or more other contributing sources to the total amount of oil and water collected from multiple contributing sources.

### BACKGROUND OF THE INVENTION

A need exists for an improved method of allocating the production of oil received and collected from multiple oil producing sources. More specifically, a need exists for a more accurate and less intrusive procedure for determining the oil production contribution of an individual source to the total amount of oil produced by and collected together (e.g., in a common oil collection tank or battery) from multiple contributing sources. The contributing sources can be any collection or combination of one or more individual wells, one or more individual groups of wells, one or more individual oil producing fields, etc.

By way of example, the drawing accompanying this application shows an oil production and collection system 2 which comprises two different oil fields (Field A and Field B) with a total of five oil producing wells (A1, A2, A3, B1, B2), all of which flow into a common oil collection battery 4. It is often helpful and many times necessary to know the contribution of oil produced from one or more of the individual wells (A1, A2, A3, B1, and/or B2) and/or one or more of the individual fields (Field A and/or Field B) into the common collection battery 4. The process of determining the contributions of individual wells and/or individual groups of wells or fields to the total amount of oil collected from all sources is referred to as “production allocation”. Such production allocation can be used for diagnosing production issues in the individual wells or fields, determining hydrocarbon ownership allotments, calculating and paying production royalties, and for regulatory reporting purposes.

Determining individual production allocations from multiple production sources is greatly complicated by the fact that the production stream flowing from each of the production sources will typically comprise an unknown combination of oil and formation water. Current methods of determining production allocation typically require that the producing wells be shut down so that extensive equipment and systems can be installed to measure the individual production rates from the wells. In addition to the loss of production which occurs during installation, the current systems used for production allocation are expensive and are not sufficiently accurate.

### SUMMARY OF THE INVENTION

The present invention provides a method and system for production allocation testing which satisfy the needs and alleviate the problems discussed above. The inventive method of production allocation testing is more accurate, less costly, and much less invasive than current methods. Moreover, the equipment needed for the inventive testing procedure is easily and quickly installed in the production lines of the individual wells or other production sources and the production sources are allowed to remain in operation during testing.

In one aspect, there is provided a method of determining a rate or amount of oil production from a production source wherein the product stream flowing from the production source comprises oil and water, the method comprising the steps of: (a) adding a tracer solution to the product stream flowing from the production source at an addition point, the tracer solution having a known concentration of at least one oil-soluble tracer and the tracer solution being added to the product stream at a rate of addition; (b) analyzing at least one sample of the product stream taken at a sampling point downstream of the addition point to determine a downstream concentration of the oil-soluble tracer in an oil phase of the product stream; and (c) determining the rate or amount of oil produced from the production source using (i) the concentration of the oil-soluble tracer in the tracer solution, (ii) the rate of addition of the tracer solution to the product stream, and (iii) the downstream concentration of the oil-soluble tracer in the oil phase of the product stream.

In another aspect wherein the product stream later combines (i.e., combines downstream of the sampling point) with one or more other product streams flowing respectively from one or more other production sources, the method can further comprise the steps of: adding a second tracer solution, at a rate of addition, to at least one of the one or more other product streams at a second tracer addition point for the at least one other product stream, the second tracer solution having a known concentration of at least one oil-soluble tracer and the second tracer solution being different from or identical to the first tracer solution; analyzing at least one sample of the at least one other product stream taken at a sampling point downstream of the second tracer addition point but prior to the combination of the at least one other product stream with the first product stream to determine a concentration of the oil-soluble tracer of the second tracer solution in an oil phase of the at least one other product stream; and determining the rate or amount of oil produced from the at least one other production source using (i) the concentration of the oil-soluble tracer of the second tracer solution in the second tracer solution, (ii) the rate of addition of the second tracer solution to the at least one other product stream, and (iii) the concentration of the oil-soluble tracer of the second tracer solution in the oil phase of the at least one other product stream.

In another aspect, there is provided a method of determining a rate or amount of oil production from a production source wherein the product stream flowing from the production source comprises oil and water, the method comprising the steps of: (a) adding a tracer solution to the product stream flowing from the production source at a tracer addition point, the tracer solution comprising a plurality of different oil-soluble tracers, each of the oil-soluble tracers being present in the tracer solution at a different concentration, and the tracer solution being added to the product stream at a rate of addition so that one or more of the oil-soluble tracers will be present in an oil phase of the product stream in a quantifiable amount; (b) analyzing at least one sample of the product stream taken at a sampling point downstream of the tracer addition point to (i) detect at least one of the oil-soluble tracers which is present in the oil phase of the product stream in a quantifiable amount and (ii) determine a concentration of the detected oil-soluble tracer in the oil phase of the product stream; and (c) determining the rate or amount of oil produced from the production source using (1) the concentration of the detected oil-soluble tracer in the tracer solution, (2) the rate of addition of the tracer solution to the product stream, and (3) the concentration of the detected oil-soluble tracer in the oil phase of the product stream.

In another aspect, this method can further comprise the steps of: combining the product stream, downstream of the sampling point thereof, with one or more other product streams flowing respectively from one or more other production sources, wherein the one or more other production sources comprises a second production source and the one or more other product streams comprises a second product stream flowing from the second production source; adding a second tracer solution to the second product stream at a second tracer addition point, the second tracer solution comprising a plurality of different oil-soluble tracers, each of the oil-soluble tracers of the second tracer solution being present in the second tracer solution at a different concentration, and the second tracer solution being added to the second product stream at a rate of addition so that one or more of the oil-soluble tracers of the second tracer solution will be present in an oil phase of the second product stream in a quantifiable amount, the second tracer solution being different from or identical to the first tracer solution; analyzing at least one sample of the second product stream taken at a sampling point downstream of the second tracer addition point but prior to the combination of the second product stream with the first product stream to (i) detect at least one of the oil-soluble tracers of the second tracer solution which is present in the oil phase of the second product stream in a quantifiable amount and (ii) determine a concentration of the detected oil-soluble tracer of the second tracer solution in the oil phase of the second product stream; and determining the rate or amount of oil produced from the second production source using (1) the concentration of the detected oil-soluble tracer of the second tracer solution in the second tracer solution, (2) the rate of addition of the second tracer solution to the second product stream, and (3) the concentration of the detected oil-soluble tracer of the second tracer solution in the oil phase of the second product stream.

In another aspect, there is provided a method of determining a rate or amount of water production from a production source wherein the product stream flowing from the production source comprises oil and water, the method comprising the steps of: (a) adding a tracer solution to the product stream flowing from the production source at an addition point, the tracer solution having a known concentration of at least one water-soluble tracer and the tracer solution being added to the product stream at a rate of addition; (b) analyzing at least one sample of the product stream taken at a sampling point downstream of the addition point to determine a downstream concentration of the water-soluble tracer in a water phase of the product stream; and (c) determining the rate or amount of water produced from the production source using (i) the concentration of the water-soluble tracer in the tracer solution, (ii) the rate of addition of the tracer solution to the product stream, and (iii) the downstream concentration of the water-soluble tracer in the water phase of the product stream.

In another aspect, there is provided a method of determining a rate or amount of water production from a production source wherein the product stream flowing from the production source comprises oil and water, the method comprising the steps of: (a) adding a tracer solution to the product stream flowing from the production source at a tracer addition point, the tracer solution comprising a plurality of different water-soluble tracers, each of the water-soluble tracers being present in the tracer solution at a different concentration, and the tracer solution being added to the product stream at a rate of addition so that one or more of the water-soluble tracers will be present in a water phase of the product stream in a quantifiable amount; (b) analyzing at least one sample of the product stream taken at a sampling point downstream of the tracer addition point to (i) detect at least one of the water-soluble tracers which is present in the water phase of the product stream in a quantifiable amount and (ii) determine a concentration of the detected water-soluble tracer in the water phase of the product stream; and (c) determining the rate or amount of water produced from the production source using (1) the concentration of the detected water-soluble tracer in the tracer solution, (2) the rate of addition of the tracer solution to the product stream, and (3) the concentration of the detected water-soluble tracer in the water phase of the product stream.

Further aspects, features, and advantages of the present invention will be apparent to those in the art upon examining the accompanying drawing and upon reading the following Detailed Description of the Preferred Embodiments.

### BRIEF DESCRIPTION OF THE DRAWING

The drawing illustrates an oil production and collection system 2 which comprises two different oil fields (Field A and Field B) with a total of five oil producing wells (A1, A2, A3, B1, B2), all of which flow into a common oil collection battery 4.

### DETAILED DESCRIPTION OF THE PREFERRED EMBODIMENTS

Referring to the drawing, the inventive production allocation method can be used to determine the rate or amount of oil and/or the rate or amount of water (e.g., formation water or brine solution, flooding water, or a combination thereof) produced from any or each of the individual production sources of the production system 2 which feed the collection battery 4. By way of example, but not by way of limitation, the individual production sources could be any individual well A1, A2, A3, B1, or B2, any individual oil field (Field A or Field B), a subgroup of wells within a field (e.g., the combination of wells A2 and A3), etc.

In order to determine the individual oil production rate or the individual water production from any of these production sources, the inventive method preferably comprises the steps of: (a) adding a tracer solution to the product stream flowing from the production source at an addition point, the tracer solution having a known concentration of at least one oil-soluble tracer (for determining the rate of oil production) or at least one water-soluble tracer (for determining the rate of water production) and the tracer solution being added to the product stream at a known rate of addition, and then (b) analyzing at least one (preferably more than one) sample of the product stream taken at a sampling point downstream of the addition point to determine a downstream concentration of the oil-soluble tracer in an oil phase, or to determine the concentration of the water-soluble tracer in a water phase, of the product stream.

For determining the rate of oil production or the rate of water production from any individual production source, both the point addition of the tracer solution to the product stream and the downstream sampling point for the product stream are located upstream of the point at which the product stream combines with any of the product streams flowing from the other production sources. Consequently, by way of example, it is noted in reference to the drawing that: (a) location 6 would be an acceptable tracer injection point and location 8 would be an acceptable sampling point for determining the oil production rate and/or the water production rate from well B1; (b) location 10 would be an acceptable tracer injection point and location 12 would be an acceptable sampling point for determining the oil production rate and/or water production rate from well A1; (c) location 14 would be an acceptable tracer injection point and location 16 would be an acceptable sampling point for determining the oil production rate and/or water production rate from all of oil Field B; and (d) location 18 would be an acceptable tracer injection point and location 20 would be an acceptable sampling point for determining the oil production rate and/or water production rate from wells A2 and A3 as a group.

For determining the oil production rate or the water production rate for an individual well, it will typically be easiest to locate the injection point for the tracer solution near the wellhead. The distance from (a) the point at which the tracer solution is injected into or otherwise added to the product stream from a production source to (b) the sampling point for the product stream can be any distance which will allow the tracer solution to mix thoroughly with the product stream prior to sampling. The distance from the tracer solution injection point to the sampling point will preferably be at least 20 meters and will more preferably be in the range of from about 30 to about 100 meters.

The tracer solution is injected into the product stream from the production source at a constant rate which will typically be in the range of from 0.1 to 5 ml/min. The tracer solution can be injected into the product stream using any device which will inject the solution at a constant rate and at a pressure which is sufficiently high for injection into the product stream. Examples of suitable devices include, but are not limited to, high pressure piston injection pumps, syringe pumps, diaphragm pumps, gear pumps, and peristaltic pumps.

The injection port used in the inventive method can be an existing valved port at the wellhead or a temporary port installed for purposes of the inventive method by removing, for example, a wellhead pressure gauge.

Alternatively, if a suitable injection port does not already exist in the piping for the product stream from the production source, an injection port can be installed in the product line comprising, for example, a ¼ inch ball valve terminated with a 1/16 inch I.D. ferrule and compression nut for receiving a length of 1/16 inch O.D. (0.001-0.01 inch I.D.) injection tubing. The injection port can be quickly installed by (1) shutting down the well, (2) disconnecting the flow line close to the wellhead, (3) installing the injection port, (4) reconnecting the flow line, (5) starting the well up, and (6) preferably letting the well flow for 48 hours before testing.

Before taking samples at the sampling point, it will preferably first be determined whether the injected tracer solution has had sufficient time to reach the sampling point at a stabilized concentration and condition. This can be accomplished, for example, by using an external Doppler flow meter to measure the flow velocity of the product stream through the product line. Using the flow velocity of the product stream, the initial arrival time of the tracer solution at the sampling point can be determined based upon the time at which the injection of the tracer solution was started and the distance from the tracer injection point to the sampling point. Moreover, prior to withdrawing any samples, an additional amount of time will preferably also be added to the calculated arrival time in order to ensure that the tracer solution has in fact arrived at the sampling point and that the concentration and condition of the tracer solution in the product stream at the sampling point have stabilized. By way of example, one effective approach is to simply double the calculated arrival time of the tracer solution prior to taking samples.

At the sampling point, a single sample, two samples, or any number of samples of the product stream can be taken and analyzed for the presence and concentration of the oil-soluble tracer in an oil phase of the product stream, or for the presence and concentration of the water-soluble tracer in a water phase (i.e., a water, brine, or other aqueous phase) of the product stream. Preferably, multiple samples will be taken and averaged. More preferably, from 3 to 5 samples will be taken at about 15 minutes or more apart.

The constant injection of the tracer solution at the injection point will preferably be continued for as long as necessary to ensure that the stabilized concentration and condition of the tracer solution in the product stream are maintained at the sampling point, at least until the final sample is taken. To ensure that this is the case, one simple approach is to continue the injection of the tracer solution until all of the samples have been taken.

Assuming that an oil-soluble tracer was used in the tracer solution, when the downstream concentration of the oil-soluble tracer in the oil phase of the product stream has been determined, the oil production rate from the production source can be determined by multiplying the concentration of the oil-soluble tracer in the tracer solution by the rate of addition (e.g., injection) of the tracer solution into the product stream and dividing by the downstream concentration of the oil-soluble tracer in the oil phase of the product stream. In addition, for a more precise answer, the rate of tracer solution addition will preferably be subtracted from this result.

Using certain metric units solely for illustration purposes, the above-described determination of the rate of oil production from the production source can be stated in terms of the following Formula 1:

((Grams of tracer/Ls)×(Ls/min)×(Lt/Grams of tracer))×Ls/min=Lo/min Formula 1

Wherein:

(Grams of tracer/Ls) is the tracer concentration of the tracer solution expressed as grams of tracer per liter of tracer solution (Ls);

Ls/min is the tracer solution injection rate expressed as liters of tracer solution (Ls) per minute;

(Lt/grams of tracer) is the inverse of downstream concentration of the oil-soluble tracer in the oil phase of the product stream expressed as the inverse of the grams of the tracer measured per liter of the oil phase of the product stream (Lt); and

Lo/min is the total oil production rate from the production source expressed as liters of oil product (Lo) per minute.

Similarly, assuming that a water-soluble tracer was used in the tracer solution, when the downstream concentration of the water-soluble tracer in the water phase of the product stream has been determined, the water production rate from the production source can be determined by multiplying the concentration of the water-soluble tracer in the tracer solution by the rate of addition (e.g., injection) of the tracer solution into the product stream and dividing by the downstream concentration of the water-soluble tracer in the water phase of the product stream. In addition, for a more precise answer, the rate of tracer solution addition will preferably be subtracted from this result.

Oil soluble tracers preferred for use in the present invention include chemical tracers which are: (a) soluble in crude oil; (b) chemically stable under the temperature, pressure and other physical conditions to which the tracer will be exposed; (c) substantially chemically inert with respect to the other components of the production stream; and (d) analytically detectable at low concentration levels (most preferably at least as low as 1 part per billion (ppb)). The oil-soluble tracers will also preferably be substantially non-soluble in water.

As used herein and in the claims, the term “oil soluble tracer” means that the tracer is sufficiently soluble in oil so that, it is miscible with the oil, or that it mixes completely with oil at any ratio.

As used herein and in the claims, the term “substantially non-soluble in water” means that the solubility of the tracer compound in water is not more than 10 grams per liter of water at 25° C. and 100 kPa.

Examples of oil soluble tracers suitable for use in the inventive method include but are not limited to oil soluble fluorobenzoates, chlorobenzoates, chloro-fluorobenzoates, bromo-chlorobenzoates, and bromo-fluorobenzoates.

Examples of oil-soluble tracers preferred for use in the present invention include, but are not limited to:
methyl 2-fluorobenzoate; Ethyl 2-fluorobenzoate; methyl 4-fluorobenzoate; Ethyl 4-fluorobenzoate; tert-butyl 4-fluorobenzoate; Ethyl 2,3,4,5-tetrafluorobenzoate; Methyl 2-(trifluoromethyl)benzoate; Ethyl 2-(trifluoromethyl)benzoate; Methyl 4-(trifluoromethyl)benzoate; ethyl 4-(trifluoromethyl)benzoate; methyl 2,5-difluorobenzoate; methyl 3-fluorobenzoate; ethyl 3-fluorobenzoate; methyl 2,6-difluorobenzoate; Ethyl 2,6-difluorobenzoate; Methyl pentafluorobenzoate; ethyl pentafluorobenzoate; methyl 3,5-difluorobenzoate; Ethyl 3,5-difluorobenzoate; methyl 2,4-difluorobenzoate; Ethyl 2,4-difluorobenzoate; methyl 3,4-difluorobenzoate; ethyl 3,4-difluorobenzoate; methyl 3,4,5-trifluorobenzoate;
Ethyl 2,3,4-trifluorobenzoate; methyl 2,4,5-trifluorobenzoate; Ethyl 2,4,5-trifluorobenzoate; methyl 2,3-difluorobenzoate; Methyl 3-(trifluoromethyl)benzoate; Ethyl 3-(trifluoromethyl)benzoate; Methyl 2-chlorobenzoate; ethyl 2-chlorobenzoate; Methyl 4-chlorobenzoate; Methyl 3-chlorobenzoate; Ethyl 2,5-dichlorobenzoate; Methyl 3,5-dichlorobenzoate; ethyl 3,5-dichlorobenzoate; Methyl 2,6-dichlorobenzoate; Ethyl 2,6-dichlorobenzoate; Methyl 3,4-dichlorobenzoate; ethyl 3,4-dichlorobenzoate; Methyl 2,4-dichlorobenzoate; ethyl 2,4-dichlorobenzoate; Methyl 2-chloro-4-fluorobenzoate; ethyl 2-chloro-4-fluorobenzoate; Ethyl 5-chloro-2-fluorobenzoate; Methyl 4-chloro-3-fluorobenzoate; Ethyl 3-chloro-4-fluorobenzoate; Ethyl 4-chloro-2-fluorobenzoate; Ethyl 5-bromo-2-chlorobenzoate; Methyl 2-bromo-5-chlorobenzoate; Methyl 2-bromo-4-fluorobenzoate; Methyl 3-bromo-4-fluorobenzoate; Ethyl 3-bromo-4-fluorobenzoate; Methyl 2-bromo-5-fluorobenzoate; Methyl 4-bromo-2-fluorobenzoate; Ethyl 4-bromo-2-fluorobenzoate; Methyl 4-bromo-3-fluorobenzoate; Methyl 3-bromo-2-fluorobenzoate; Methyl 3-bromo-2,5-difluorobenzoate; and Ethyl 2-bromo-4,5-difluorobenzoate.

The tracer solution for the oil-soluble tracer will also comprise a solvent or carrier in which the oil-soluble tracer is dissolved or dispersed. Examples of solvents or carriers preferred for use in the tracer solution for the oil-soluble tracer include but are not limited to: mineral spirits, octanol, hexane, and heptane. The oil-soluble tracer will preferably be present in the tracer solution at a concentration in the range of from 5 to 50,000 ppm by weight. The oil-soluble tracer will more preferably be present in the tracer solution at a concentration in the range of from 50 to 5000 ppm by weight.

In an alternative embodiment, the tracer solution for determining the oil production rate from the production source can comprise two, three, or more different oil-soluble tracers of the type discussed above. In addition, each of the tracers will preferably be present in the tracer solution at a different concentration so that even if the actual oil production rate from the production source turns out to be very low or very high, one or more of the oil-soluble tracers will be present in the oil phase of the product stream at the sampling point in a quantifiable amount. For sample analysis using high performance liquid chromatography with a mass spectrographic detector, or for other techniques such as gas chromatography-mass spectrometry (GC/MS) or high-performance liquid chromatograph-UV (HPLC/UV) analysis, a quantifiable amount of an oil-soluble tracer of the type discussed above will typically be at least 5 ppb by weight of the oil phase of the sample and will preferably be in the range of from 50 to 500 ppb by weight of the oil phase.

Consequently, by way of example, for testing an unknown product stream from a production source which could potentially contain anywhere from 1 to 500 barrels per day of crude oil and where the tracer solution is added to the product stream at a rate of from 0.5 to 5 ml per minute, the tracer solution could desirable comprise two different oil-soluble tracers, one of the tracers preferably being present in the tracer solution at a low concentration in the range of from 50 to 500 ppm by weight and the other being present in the tracer solution at a high concentration in the range of from 5000 to 10,000 ppm by weight. More preferably, for a possible crude production rate of anywhere from 1 to 500 barrels per day, the tracer solution could desirably comprise three different oil-soluble tracers, one of the tracers preferably being present in the tracer solution at a low concentration in the range of from 50 to 500 ppm by weight, a second of the tracers preferably being present at an intermediate concentration in the range of from 500 to 5000 ppm by weight, and the third tracer preferably being present in the tracer solution at a high concentration in the range of from 5000 to 10,000 ppm by weight.

Water soluble tracers preferred for use in the present invention include chemical tracers which are: (a) soluble in water; (b) chemically stable under the temperature, pressure and other physical conditions to which the tracer will be exposed; (c) substantially chemically inert with respect to the other components of the production stream; and (d) analytically detectable at low concentration levels (most preferably at least as low as 1 ppb). The water-soluble tracers will also preferably be substantially non-soluble in crude oil.

The tracer solution for the water-soluble tracer will also comprise a solvent or carrier in which the water-soluble tracer is dissolved or dispersed. Examples of solvents or carriers preferred for use in the tracer solution for the water-soluble tracer include but are not limited to: water, 2-propanol, methanol, ethanol, acetonitrile, and brine. The water-soluble tracer will preferably be present in the tracer solution at a concentration in the range of from 5 to 50,000 ppm by weight. The water-soluble tracer will more preferably be present in the tracer solution at a concentration in the range of from 50 to 5000 ppm by weight.

As used herein and in the claims, the term “water soluble tracer” means that the tracer is sufficiently soluble in water so that the tracer will dissolve in water at the tracer solution concentrations provided above or higher.

As used herein and in the claims, the term “substantially non-soluble in crude oil” means that the solubility of the tracer compound in crude oil is not more than 1 gram per liter of oil at 25° C. and 100 kPa.

Examples of water soluble tracers suitable for use in the inventive method include but are not limited to water soluble sulfonic acids, fluorobenzoic acids, chlorobenzoic acids, chloro-fluorobenzoic acids, bromo-chlorobenzoic acids, and bromo-fluorobenzoic acids.

Examples of water-soluble tracers preferred for use in the present invention include, but are not limited to:
1,3,6-naphalenetrisulfonic acid; 1,3,5-naphalenetrisulfonic acid; 2,7-naphalenedisulfonic acid; 1,5-naphalenedisulfonic acid; 1-naphalenesulfonic acid; 2,6-naphalenedisulfonic acid; 1,3,6,8-pyrenetetrasulfonic acid; 1,6-naphalenedisulfonic acid; 2-Fluorobenzoic acid; 4-Fluorobenzoic acid; 2,3,4,5-tetrafluorobenzoic acid; 2-(Trifluoromethyl)benzoic acid; 4-(Trifluoromethyl)benzoic acid; 2,5-difluorobenzoic acid; 3-fluorobenzoic acid; 2,6-difluorobenzoic acid; Pentafluorobenzoic acid; 3,5-difluorobenzoic acid; 2,4-difluorobenzoic acid; 3,4-difluorobenzoic acid; 3,4,5-trifluorobenzoic acid; 2,3,4-trifluorobenzoic acid; 2,4,5-trifluorobenzoic acid; 2,3-difluorobenzoic acid; 3-(trifluoromethyl)benzoic acid; 2-chlorobenzoic acid; 4-chlorobenzoic acid; 3-chlorobenzoic acid; 2,3-dichlorobenzoic acid; 2,5-dichlorobenzoic acid; 3,5-dichlorobenzoic acid; 2,6-dichlorobenzoic acid; 3,4-dichlorobenzoic acid; 2,4-dichlorobenzoic acid; 2-chloro-4-fluorobenzoic acid; 5-chloro-2-fluorobenzoic acid; 4-chloro-3-fluorobenzoic acid; 3-chloro-4-fluorobenzoic acid; 4-chloro-2-fluorobenzoic acid; 5-bromo-2-chlorobenzoic acid; 2-bromo-5-chlorobenzoic acid; 2-bromo-4-fluorobenzoic acid; 3-bromo-4-fluorobenzoic acid; 2-bromo-5-fluorobenzoic acid; 4-bromo-2-fluorobenzoic acid; 4-bromo-3-fluorobenzoic acid; 3-bromo-2-fluorobenzoic acid; 3-bromo-2,5-difluorobenzoic acid; and 2-bromo-4,5-difluorobenzoic acid.

In an alternative embodiment, the tracer solution for determining the water production rate from the production source can comprise two, three, or more different water-soluble tracers of the type discussed above. In addition, the tracers will preferably be present in the tracer solution at different concentrations so that even if the actual water production rate from the production source turns out to be very low or very high, one or more of the water-soluble tracers will be present in the water phase of the product stream at the sampling point in a quantifiable amount. For sample analysis using high performance liquid chromatography with a mass spectrographic detector, or for other techniques such as HPLC/UV or HPLC/FLD analysis, a quantifiable amount of a water-soluble tracer of the type discussed above will typically be at least 5 ppb by weight of the water phase of the sample and will preferably be in the range of from 50 to 500 ppb by weight of the water phase.

By way of example, for testing an unknown product stream from a production source which could potentially contain anywhere from 1 to 1000 barrels per day of water and where the tracer solution is added to the product stream at a rate of from 0.5 to 5 ml per minute, the tracer solution could desirably comprise two different water-soluble tracers, one of the tracers preferably being present in the tracer solution at a low concentration in the range of from 50 to 500 ppm by weight and the other being present in the tracer solution at a high concentration in the range of from 5000 to 10,000 ppm by weight. More preferably, for a possible water production rate of anywhere from 1 to 1000 barrels per day, the tracer solution could desirably comprise three different water-soluble tracers, one of the tracers preferably being present in the tracer solution at a low concentration in the range of from 50 to 500 ppm by weight, a second of the tracers preferably being present at an intermediate concentration in the range of from 500 to 5000 ppm by weight, and the third tracer preferably being present in the tracer solution at a high concentration in the range of from 5000 to 10,000 ppm by weight.

Referring again to the production system 2 illustrated in the drawing, the above described oil-soluble tracer testing and water-soluble tracer testing procedures can be used to determine the rate or amount of oil production and/or the rate or amount of water production from any single production source (e.g., well A1, A2, A3, B1, or B2, Field A or Field B, etc.) of the production system 2 which feeds the common collection battery 4. Alternatively, the same inventive procedures can be used to determine the individual oil production rates and/or water production rates, prior to combination with the production streams flowing from other sources, of any two, three, or more or each one of the production sources (e.g., well A1, A2, A3, B1, or B2, Field A or Field B, etc.) of the production system 2.

When using the inventive procedure or procedures described above for determining the individual oil production rates and/or the individual water production rates from any two or more of the production sources, the oil-soluble tracer solutions and/or water-soluble tracer solutions used for determining the oil and/or water production rates from each of the individual sources can be the same oil-soluble tracer solutions and/or water-soluble tracer solutions or they can be different solutions using (a) different oil-soluble or water-soluble tracers and/or (b) different concentration profiles.

The following example is meant to illustrate, but in no way limit, the claimed invention.

### EXAMPLE

The inventive method was used to determine the individual oil production rates of three wells which all fed into a common collection battery. In each case, a tracer solution injection port was installed in the product line of the well within 1 meter of the wellhead. The injection port for each of the well production lines comprised a ¼ inch ball valve terminated with a 1/16 inch I.D. ferrule and compression nut for receiving a length of 1/16 inch O.D. injection tubing.

The oil-soluble tracer solution used for testing each of the wells was a mineral spirit solution comprising 500 ppm by weight of Ethyl 3-Chlorobenzoate, 1000 ppm by weight of Ethyl 2,3,4-Triflourobenzoate, and 5000 ppm by weight of Ethyl 2,4-Diflourobenzoate. In each case, the oil-soluble tracer solution was injected into the production line, via the injection tube, at a constant rate of 0.5 ml per minute using a high pressure piston injection pump.

The sampling point for each well was located in the product line downstream of the injection port but prior the point at which the product stream combined with the product streams from any of the other wells. The velocity of flow through each of the well product lines was measured using an external flow meter and was used to determine the time of arrival of the injected tracer solution at the sampling point. The calculated travel time for each well was doubled in order to ensure that no samples were taken until the concentration and condition of the tracer solution in the product stream at the sampling point had stabilized.

For each well product stream, six samples were taken and the results were averaged and compared to an estimated oil production rate for the well provided by the well operator.

The samples from the well production streams were collected in a separatory funnel in which the oil phase of the sample separated from the water phase. The oil phase was then analyzed using a high performance liquid chromatography system with a mass spectrographic detector to (a) detect at least one of the injected oil-soluble tracers present in the oil phase in a quantifiable amount and (b) determine the concentration of the detected tracer in the oil phase. Next, the Formula 1 recited above was used to calculate the oil production rate from the well and this result was converted to barrels of oil per day (BOD).

The oil production results (i.e., allocations) for each of the three wells tested were as follows:

Well #1 BOD results
15.09719
12.16861
11.58352
10.07375
12.62307
11.91883

### Average of 12.2 BOD

Estimated production rate from well operator: 10 BOD

Well#2 BOD results
8.989989
10.77345
8.545578
10.24696
11.03596
9.59567

### Average of 9.8 BOD

Estimated production rate from well operator: 10 BOD

Well #3 BOD results
1.854388
3.626226
2.322644
2.903305
3.17079
2.852114

### Average of 2.8 BOD

Estimated production rate from well operator: 3 BOD

The test results from all three of the wells were within 5% of the estimated oil production rate given by the well operator.

Thus, the present invention is well adapted to carry out the objectives and attain the ends and advantages mentioned above as well as those inherent therein. While presently preferred embodiments have been described for purposes of this disclosure, numerous changes and modifications will be apparent to those in the art. Such changes and modifications are encompassed within this invention as defined by the claims.

What is claimed:

1. A method of determining a rate or amount of oil production from a production source wherein a product stream flowing from the production source comprises oil and water, the method comprising the steps of:
a) adding a tracer solution to the product stream flowing from the production source at an addition point, the tracer solution having a known concentration of at least one oil-soluble tracer and the tracer solution being added to the product stream at a rate of addition;
b) analyzing at least one sample of the product stream taken at a sampling point downstream of the addition point to determine a downstream concentration of the oil-soluble tracer in an oil phase of the product stream; and
c) determining the rate or amount of oil produced from the production source using (i) the concentration of the oil-soluble tracer in the tracer solution, (ii) the rate of addition of the tracer solution to the product stream, and (iii) the downstream concentration of the oil-soluble tracer in the oil phase of the product stream.

2. The method of claim 1 wherein the rate or amount of oil produced from the production source is determined at least in part in step (c) by multiplying the concentration of the oil-soluble tracer in the tracer solution by the rate of addition of the tracer solution to the product stream and dividing by the downstream concentration of the oil-soluble tracer in the oil phase of the product stream.

3. The method of claim 1 further comprising the steps of:
determining a velocity of flow of the product stream flowing from the production source;
calculating from the velocity of flow of the product stream and from a beginning time of step (a) whether the tracer solution added to the product steam has arrived at the sampling point downstream of the addition point; and
performing step (c) after the tracer solution added to the product steam has arrived at the sampling point downstream of the addition point as determined in said step of calculating.

4. The method of claim 3 further comprising continuing to add the tracer solution to the product stream in accordance with step (a) at least until the sample of the product stream is taken at the sampling point.

5. The method of claim 3 wherein the velocity of flow of the product stream flowing from the production source is determined using a Doppler flow meter.

6. The method of claim 1 wherein step (b) comprises collecting or placing the sample of the product stream in a separatory funnel in which the oil phase separates from a water phase.

7. The method of claim 1 wherein the oil-soluble tracer is a fluorobenzoate, a chlorobenzoate, a chloro-fluorobenzoate, a bromo-chlorobenzoate, or a bromo-fluorobenzoate.

8. The method of claim 1 wherein the production source is a single oil well, a group of two or more oil wells, or an oil producing field.

9. The method of claim 1 wherein:
the production source is a first production source, the product stream is a first product stream, and the tracer solution is a first tracer solution and
downstream of the sampling point of the first product stream, the first product stream combines with one or more other product streams flowing respectively from one or more other production sources.

10. The method of claim 9 further comprising the steps of:
adding a second tracer solution, at a rate of addition, to at least one of the one or more other product streams at a second tracer addition point for the at least one other product stream, the second tracer solution having a known concentration of at least one oil-soluble tracer and the second tracer solution being different from or identical to the first tracer solution;
analyzing at least one sample of the at least one other product stream taken at a sampling point downstream of the second tracer addition point but prior to the combination of the at least one other product stream with the first product stream to determine a concentration of the oil-soluble tracer of the second tracer solution in an oil phase of the at least one other product stream; and
determining the rate or amount of oil produced from the at least other production source using (i) the concentration of the oil-soluble tracer of the second tracer solution in the second tracer solution, (ii) the rate of addition of the second tracer solution to the at least one other product stream, and (iii) the concentration of the oil-soluble tracer of the second tracer solution in the oil phase of the at least one other product stream.

11. The method of claim 9 wherein the one or more other production sources comprises a second production source, the one or more other product streams comprises a second product stream flowing from the second production source, and the method further comprises the steps of:
adding a second tracer solution, at a rate of addition, to the second product stream at a second tracer addition point, the second tracer solution having a known concentration of at least one oil-soluble tracer and the second tracer solution being different from or identical to the first tracer solution;
analyzing at least one sample of the second product stream taken at a sampling point downstream of the second tracer addition point but prior to the combination of the second product stream with the first product stream to determine a concentration of the oil-soluble tracer of the second tracer solution in an oil phase of the second product stream; and
determining the rate or amount of oil produced from the second production source using (i) the concentration of the oil-soluble tracer of the second tracer solution in the second tracer solution, (ii) the rate of addition of the second tracer solution to the second product stream, and (iii) the concentration of the oil-soluble tracer of the second tracer solution in the oil phase of the second product stream.

12. The method of claim 11 wherein:
the first production source is a single well, a group of two or more wells, or an oil producing field and
the second production source is a single well, a group of two or more wells, or an oil producing field.

13. The method of claim 1 further comprising the steps of:
adding, at a rate of addition and at an addition point, a tracer solution comprising a known concentration of a water-soluble tracer to the product stream flowing from the production source;
analyzing at least one sample of the product stream taken at a sampling point downstream of the addition point of the tracer solution comprising the known concentration of the water-soluble tracer to determine a downstream concentration of the water-soluble tracer in a water phase of the product stream; and
determining the rate or amount of water produced from the production source using (i) the concentration of the water-soluble tracer in the tracer solution comprising the known concentration of the water-soluble tracer, (ii) the rate of addition of the tracer solution comprising the known concentration of the water-soluble tracer to the product stream, and (iii) the downstream concentration of the water-soluble tracer in the water phase of the product stream.

14. A method of determining a rate or amount of oil production from a production source wherein a product stream flowing from the production source comprises oil and water, the method comprising the steps of:
a) adding a tracer solution to the product stream flowing from the production source at a tracer addition point, the tracer solution comprising a plurality of different oil-soluble tracers, each of the oil-soluble tracers being present in the tracer solution at a different concentration, and the tracer solution being added to the product stream at a rate of addition so that one or more of the oil-soluble tracers will be present in an oil phase of the product stream in a quantifiable amount;
b) analyzing at least one sample of the product stream taken at a sampling point downstream of the tracer addition point to (i) detect at least one of the oil-soluble tracers which is present in the oil phase of the product stream in a quantifiable amount and (ii) determine a concentration of the detected oil-soluble tracer in the oil phase of the product stream; and
c) determining the rate or amount of oil produced from the production source using (i) the concentration of the detected oil-soluble tracer in the tracer solution, (ii) the rate of addition of the tracer solution to the product stream, and (iii) the concentration of the detected oil-soluble tracer in the oil phase of the product stream.

15. The method of claim 14 wherein step (b) comprises collecting or placing the sample of the product stream in a separatory funnel in which the oil phase separates from a water phase of the sample of the product stream.

16. The method of claim 14 wherein each of the different oil-soluble tracers in the tracer solution is a fluorobenzoate, a chlorobenzoate, a chloro-fluorobenzoate, a bromo-chlorobenzoate, or a bromo-fluorobenzoate.

17. The method of claim 14 wherein the production source is a first production source, the product stream is a first product stream, the tracer solution is a first tracer solution and the method further comprises the steps of:
downstream of the sampling point of the first product stream, combining the first product stream with one or more other product streams flowing respectively from one or more other production sources, wherein the one or more other production sources comprises a second production source and the one or more other product streams comprises a second product stream flowing from the second production source;
adding a second tracer solution to the second product stream at a second tracer addition point, the second tracer solution comprising a plurality of different oil-soluble tracers, each of the oil-soluble tracers of the second tracer solution being present in the second tracer solution at a different concentration, and the second tracer solution being added to the second product stream at a rate of addition so that one or more of the oil-soluble tracers of the second tracer solution will be present in an oil phase of the second product stream in a quantifiable amount, the second tracer solution being different from or identical to the first tracer solution;
analyzing at least one sample of the second product stream taken at a sampling point downstream of the second tracer addition point but prior to the combination of the second product stream with the first product stream to (i) detect at least one of the oil-soluble tracers of the second tracer solution which is present in the oil phase of the second product stream in a quantifiable amount and (ii) determine a concentration of the detected oil-soluble tracer of the second tracer solution in the oil phase of the second product stream; and
determining the rate or amount of oil produced from the second production source using (i) the concentration of the detected oil-soluble tracer of the second tracer solution in the second tracer solution, (ii) the rate of addition of the second tracer solution to the second product stream, and (iii) the concentration of the detected oil-soluble tracer of the second tracer solution in the oil phase of the second product stream.

18. The method of claim 17 wherein:
the first production source is a single oil well, a group of two or more oil wells, or an oil producing field and
the second production source is a single oil well, a group of two or more oil wells, or an oil producing field.

19. A method of determining a rate or amount of water production from a production source wherein a product stream flowing from the production source comprises oil and water, the method comprising the steps of:
a) adding a tracer solution to the product stream flowing from the production source at an addition point, the tracer solution having a known concentration of at least one water-soluble tracer and the tracer solution being added to the product stream at a rate of addition;
b) analyzing at least one sample of the product stream taken at a sampling point downstream of the addition point to determine a downstream concentration of the water-soluble tracer in a water phase of the product stream; and
c) determining the rate or amount of water produced from the production source using (i) the concentration of the water-soluble tracer in the tracer solution, (ii) the rate of addition of the tracer solution to the product stream, and (iii) the downstream concentration of the water-soluble tracer in the water phase of the product stream.

20. The method of claim 19 wherein the water-soluble tracer is a sulfonic acid, a fluorobenzoic acid, a chlorobenzoic acid, a chloro-fluorobenzoic acid, a bromo-chlorobenzoic acid, or a bromo-fluorobenzoic acid.

21. A method of determining a rate or amount of water production from a production source wherein a product stream flowing from the production source comprises oil and water, the method comprising the steps of:
a) adding a tracer solution to the product stream flowing from the production source at a tracer addition point, the tracer solution comprising a plurality of different water-soluble tracers, each of the water-soluble tracers being present in the tracer solution at a different concentration, and the tracer solution being added to the product stream at a rate of addition so that one or more of the water-soluble tracers will be present in a water phase of the product stream in a quantifiable amount;
b) analyzing at least one sample of the product stream taken at a sampling point downstream of the tracer addition point to (i) detect at least one of the water-soluble tracers which is present in the water phase of the product stream in a quantifiable amount and (ii) determine a concentration of the detected water-soluble tracer in the water phase of the product stream; and
c) determining the rate or amount of water produced from the production source using (i) the concentration of the detected water-soluble tracer in the tracer solution, (ii) the rate of addition of the tracer solution to the product stream, and (iii) the concentration of the detected water-soluble tracer in the water phase of the product stream.

22. The method of claim 21 wherein each of the water-soluble tracers is a sulfonic acid, a fluorobenzoic acid, a chlorobenzoic acid, a chloro-fluorobenzoic acid, a bromo-chlorobenzoic acid, or a bromo-fluorobenzoic acid.
